(19) United States
(12) Patent Application Publication
(10) Pub. No.: US 2015/0100485 A1
(43) Pub. Date: Apr. 9, 2015

(54) BIOMETRIC CONFIRMATION FOR BANK CARD TRANSACTION

(71) Applicant: SAFE SIGN LTD, Ashkelon (IL)

(72) Inventor: Evgney Skliar, Ashkelon (IL)

(21) Appl. No.: 14/398,736

(22) PCT Filed: Jun. 10, 2013
(86) PCT No.: PCT/IB13/54729

§ 371 Date: Nov. 4, 2014

Related U.S. Application Data
(60) Provisional application No. 61/657,808, filed on Jun. 10, 2012.

(51) Int. Cl. G06Q 20/40; G07F 7/12; G06F 21/32

(52) U.S. Cl. CPC G06Q 20/40145; G06F 21/32; G07F 7/122
USPC 705/41

(57) ABSTRACT

A device and method for biometric authentication of ownership of a bank card, including: (a) a smart card reader adapted to communicate with a smart chip operationally coupled to the bank card; and (b) a biometric sampler, configured to collect biometric sample data from a user of the bank card, wherein the device is configured to cross reference the collected biometric sample data with biometric reference data stored on the smart chip, and wherein a correlation between the collected biometric sample data and the biometric reference data authenticates the user as an owner of the bank card.

This patent application claims priority from and the benefit of U.S. Provisional Patent Application No. 61/657,808, filed Jun. 10, 2012

### FIELD AND BACKGROUND OF THE INVENTION

The bank card world is full of different types of frauds. For example, the annual losses in the US alone due to credit card frauds are estimated to be in the order of 2.4 Billion US$. In some countries, the credit card companies have introduced the use of Chip & Pin protocols, where the user has to authenticate himself (or herself) using a secret PIN associated with the credit card. While such measures reduce fraudulent behavior, they suffer from several pitfalls: delays in transaction processing (as entering the PIN takes a few additional seconds, including mistaken PINs), PINs can be transferred between people, and finally, PINs can be forgotten, requiring costly recovery procedures, to name a few of the main drawbacks.

It would be highly advantageous to have a system and method whereby a bank card transaction is verified in a quick and secure manner, preferably based on biometric data verification or ‘biometric authentication’.

### SUMMARY OF THE INVENTION

According to the present invention there is provided device for biometric authentication of ownership of a bank card, including: (a) a smart card reader adapted to communicate with a smart chip operationally coupled to the bank card; and (b) a biometric sampler, configured to collect biometric sample data from a user of the bank card, wherein the device is configured to cross reference the collected biometric sample data with biometric reference data stored on the smart chip, and wherein a correlation between the collected biometric sample data and the biometric reference data authenticates the user as an owner of the bank card.

According to further features in preferred embodiments of the invention described below biometric reference data is stored in a manner so as to allow verification while preventing extraction of the biometric reference data by a third party.

According to still further features in the described preferred embodiments the biometric reference data is manipulated using a one-way function that prevents deduction of the biometric reference data from the stored biometric reference data.

According to still further features the biometric reference data is subjected to an algorithm selected from the group of secure cryptographic hash functions.

According to still further features the biometric reference data is sampled and stored using a secure mechanism that allows high-probability authentication (i.e. high probability for true positives and low probability of false negatives), prevents inversion of the stored biometric reference data, and is adapted to tolerate an accepted variance between the biometric sample data and the biometric reference data.

According to still further features the biometric sample data correlates to the stored biometric reference data in a predefined manner.

According to still further features wherein, prior to storage, the biometric reference data are subjected to at least one algorithm selected from the group comprising: a fuzzy extractor algorithm, secure sketch algorithm and a secure sketch-like algorithm.

According to still further features the communication between the reader and the smart chip is protected against third party manipulation.

According to still further features the communication between the reader and the smart chip includes a validation process.

According to still further features the validation process includes exchanging cryptographic keys between the reader and the smart chip.

According to still further features the validation process includes encrypting the communication.

According to still further features a level of authentication is adapted to be manipulated according to a desired level of security.

According to still further features the smart chip includes a communication interface selected from the group comprising: a contact communication interface, a contactless communication interface and a hybrid contact and contactless duel communication interface.

According to still further features the smart card reader is further adapted to acquire bank card data of the bank card from the smart chip.

According to still further features the smart card reader is operationally coupled to the biometric sampler in a manner selected from the group comprising: a wired manner and a wireless manner.

According to still further features the device is configured to be operationally coupled to a bank card reader.

According to still further features the device is further configured to request bank card data verification prior to approval of a transaction request.

According to still further features the transaction request if for a transaction selected from the group comprising: a card-present transaction and a card-not-present transaction.

According to still further features the biometric sampler is included in a smart phone.

According to another embodiment there is provided a method for authenticating ownership of a bank card using a biometric sample, including the steps of: (a) collecting biometric sample data; (b) acquiring biometric reference data from a smart chip operationally coupled to the bank card; and (c) cross-referencing the biometric sample data with the biometric reference data to determine whether the biometric sample data sufficiently matches the biometric reference data to authenticate ownership of the bank card.

According to further features the method further includes the step of: (d) disabling the bank card when the biometric sample data fails to sufficiently match the biometric reference data after a predetermined number of attempts to provide the biometric sample data.

According to still further features the step of disabling the bank card includes at least one action selected from the group comprising: blocking the bank card and erasing the biometric reference data from the smart card.

According to still further features the method further includes the steps of: (d) acquiring bank card data related to the bank card; and (e) receiving verification of the bank card data from a verifying body.

According to still further features the bank card data is acquired by a smart card reader.

According to still further features the bank card data is acquired by a legacy bank card reader.

According to still further features the method further comprises the step of: (f) approving a transaction request based on the verification of the bank card data and the authentication of ownership of the bank card.

According to still further features the transaction request is for a card-present transaction.

According to still further features the transaction request is for a card-not-present transaction.

According to still further features the biometric sample data is acquired by a biometric sampling device.

According to still further features the biometric sampling device is included in a smart phone.

According to still further features the method further includes the step of: (d) approving a transaction request for the bank card based on the authentication of ownership of the bank card and at least one additional form of identification, wherein the at least one additional form of identification is selected from the group comprising: a signature, voice authentication, a password, a PIN code, behaviometric data and credit card data verification.

According to still further features the method further includes the step of: (d) approving a transaction request for the bank card based only on the authentication of ownership of the bank card.

According to still further features the method further includes the step of: (d) storing the biometric reference data, prior to step (a), in a manner so as to allow verification while preventing extraction of the biometric reference data by a third party.

According to still further features the method further includes the step of: (e) manipulating the biometric reference data using a one-way function that prevents deduction of the biometric reference data from the stored biometric reference data.

According to still further features the method further includes the step of: (e) subjecting the biometric reference data to an algorithm selected from the group of secure cryptographic hash functions.

According to still further features the method further includes the step of: (d) sampling and storing the biometric reference data, prior to step (a), a using secure mechanism that allows high-probability authentication, prevents inversion of the stored biometric reference data, and is adapted to tolerate an accepted variance between the biometric sample data and the biometric reference data.

According to still further features the method further includes the step of: (e) subjecting the biometric reference data, prior to the step of storing, to at least one algorithm selected from the group comprising: a fuzzy extractor algorithm, a secure sketch algorithm and a secure sketch-like algorithm.

The currently described invention is based on replacing the authentication by

PIN with an authentication using biometric data (and in addition possibly other factors of authentication, such as digital recognition of the hand-written signature, or the use of PINs or passwords), thus preventing the case of lost authentication data, improving the speed of authentication (as the speed can now be controlled by the level of authentication needed), and prevent the possibility of transferring authentication credentials from one user to another one.

### BRIEF DESCRIPTION OF THE DRAWINGS

Various embodiments are herein described, by way of example only, with reference to the accompanying drawings, wherein:

FIG. 1 is a pictorial flow chart/diagram of a first configuration of immediate invention;

FIG. 2 is a pictorial flow chart/diagram of a second configuration of the immediate invention;

FIG. 3 is a pictorial flow chart/diagram of a third configuration of the immediate invention.

### DESCRIPTION OF THE PREFERRED EMBODIMENTS

While biometric authentication has been around for several years now, it has never been used in the context of payment methods in a widely deployed system, allowing a multitude of users authenticating themselves in any given time.

The invention discussed herein is a system for the authentication of bank card owner that can be incorporated into the bank card system. For the purposes of this disclosure, the term ‘smart card’ is used to refer to a smart chip integrated or embedded in a bank card. The terms ‘credit card’ and ‘bank card’ are used interchangeably herein. That is to say that while a credit card is only one type of bank card (and different from an ATM card, a charge card, a debit card etc.), it is to be understood that whenever the term ‘credit card’ is used, usage is merely exemplary and intended to refer equally (where applicable) to other types of bank cards. The system is based on two elements:

1. a smart card reader for reading smart cards embedded bank cards, and

2. a device to measure the biometric data of a user, i.e. a biometric sampling device; this device communicates with the smart card in order to authenticate the owner of the bank card by cross referencing the sampled biometric data with the biometric data stored on the smart card chip embedded in the bank card. The biometric data stored on the chip is termed herein as ‘biometric reference data’.

In some embodiments, other forms of identification may be incorporated into the system besides the biometric data, such as identification of the hand-written signature, voice authentication or the usage of passwords/PINs. ‘Behaviometrics’ are behavioral biometrics related to the behavior of a person, including but not limited to:

typing rhythm, gait, and voice (although voice is a physiological trait, as every person has a unique vocal tract, voice recognition is considered herein to be “behavioral” as a voice is affected by the mood of the speaker). The aforementioned additional security factors are not mandatory, and their use depends on the selected tradeoff between security and speed of authentication.

To prevent the need for an online database that has to authorize each and every transaction (i.e., authenticate each and every user), the biometric reference data is stored on the smart card embedded in the bank card, and is signed by the bank/issuer of the bank card, whereas the signature keys are distributed using a standard certificate-based PKI (Public-Key Infrastructure—where the certificate of the bank/issuer may also be stored on. the smart card to allow offline systems to authenticate owners of such credit cards). In some embodiments the biometric reference data is encrypted. In other embodiments the data is otherwise secured against cloning, malicious attacks, unauthorized extraction, reverse engineering and the like. In some embodiments the data is stored in a manner in which the data cannot be inverted. For example, the data is hashed or digested.

In some preferred embodiments a hash function is used to safeguard the data. To this end, the hash value of a piece of data (e.g. a fingerprint, voiceprint, plain data, etc.) can be stored, where the hash value is denoted by h(data). When the data is reintroduced, for example as data', it is possible to easily compute h(data') and compare the resulting value to the stored h(data). Using a good hash function, the likelihood that data is not equal to data, and their hash values agree is negligible. One key element of good cryptographic hash functions is the fact that deducing data from h(data) is impossible. Thus, a hacker obtaining h(data), would need to compute h(data') on many data' (e.g. billions of billions of billions) of possible fingerprints, before finding one that hashes to the given h(fingerprint).

At the same time, to protect user privacy in case of a credit-card loss, the biometric data stored on the smart card is stored in a format which allows verifying whether a given person with a given biometric data indeed corresponds to the stored data, while preventing the extraction of the same data by a third party. That is to say that the biometric data cannot be extracted from the smart card, even if the smart card is hacked. In one embodiment of the invention, only partial data or otherwise protected data is stored on the smart card. Extracted biometric data is incomplete and unusable. Only the correlation between the stored data and the currently inputted biometric data allows authentication. Therefore if a bank card is stolen, the data that can be extracted from the embedded smart card cannot be used in place of the owner's fingerprint or iris scan or any other biometric sample.

In another more preferred embodiment, the biometric data is stored in a manner which allows verification, but allows no extraction whatsoever of the biometric data from the card. To this end, the biometric reference data which is sampled by the entities authorizing the biometric data on the card is hashed using a suitable one-way function which prevents inversion of the biometric data.

The data is subjected to an algorithm from the family of cryptographic hash functions. Examples of such algorithms include SHA-a, SHA-256, or KECCAK. In an even more preferred embodiment, fuzzy extractors (a cryptographic mechanism designed for biometric data specifically for similar applications) are used in ₜhe encryption process.

Alternatively and or additionally, the smart card is protected by advanced encryption and security measures which prevent unauthorized reading of non-volatile memory and/or private keys. Security measures for protecting attacks on smart cards are well known in the art and continually evolve and improve.

At the time of credit-card use, the user has his or her biometric data sampled using the reader device (possibly with other authentication information, as seen fit by the credit card companies), and the sampled data is compared to the data stored on the smart card itself. The comparison is done on the smart card to reduce the threat of a malicious reader obtaining illegitimate access. If the comparison fails, the user is probed again, and after a number of failed attempts the card may be blocked (and an alert shall be sent through the reader to the issuer of the credit card).

Alternatively and/or additionally, the device may incorporate a self-destruct mechanism. The self-destruct mechanism erases the personal information (stored biometric data) of the user and/or the software stored in the smart card in order to prevent malicious use of the data. Activation of the self-destruct mechanism is at the discretion of the issuer of the card, and may depend on predetermined number of failed usage attempts, the detection of software/hardware probing the system, or by a command issued by the issuer of the card through a reader. Once the self-destruct option is activated, the relevant data is completely and irrevocably wiped from the card. Once a smart card has been ‘wiped’ the user must reactivate the card at the POI (Point of Issue) or have a card reissued (all contingent on the security arrangements of the issuing institution and/or financial institution). Similar precautions may be deployed in the card reader systems.

Communication between the device and the smart card is protected against third party manipulation (the device has a public key for purposes of authenticating its origin). Before each communications with the smart card, the smart card validates the reader (ensuring that the reader is a legitimate reader issued by the real credit card issuer) to prevent a malicious reader from obtaining the data stored on the card by means of a trivial reading of the smart card memory. In some embodiments of the system, the reader and the smart card exchange cryptographic keys as part of the validation process to not only authenticate the communication, but also to encrypt the communication, thus allowing the use of contact-less smart cards (e.g. an RFID smart card). Additionally, the smart card is protected from physical manipulation. For example, SRAM Physical Unclonable Functions (PUF) technology integrated in NXP® next-generation Smart Card ICs.

Finally, in some embodiments, the reader includes a feature for varying the level of authentication, allowing for the manipulation of the reader device to set the level of authentication higher or lower. For example, the authentication level can be lowered to increase the speed of a transaction (at the cost of a possible fraud) for low sums of money, or to increase the security required by setting the level of authentication higher for large sums of money (at the trade off of a slower process).

The principles and operation of a biometric authentication system for bank card transactions according to the present invention may be better understood with reference to the drawings and the accompanying description.

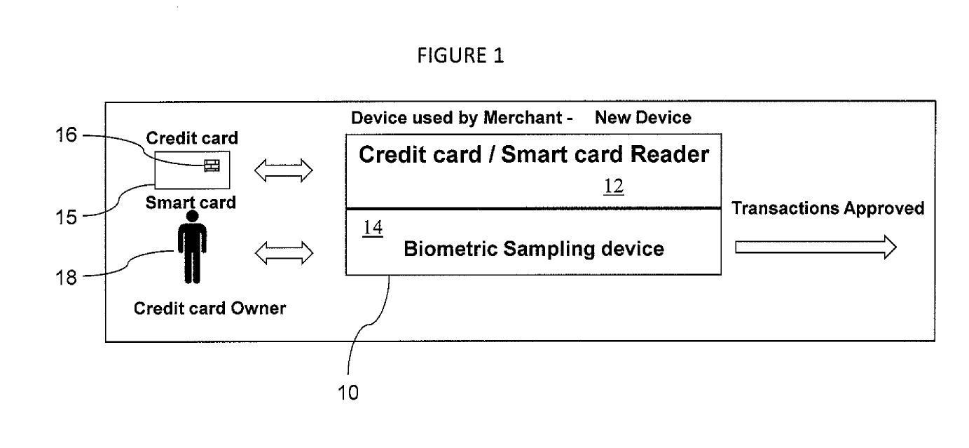

The present invention includes two configurations for incorporating the immediate invention into card present transactions. In the first configuration, the reader device replaces an existing credit-card reader device. In the second configuration, an innovative reader device is used in conjunction with an existing credit-card reader. Referring now to the drawings, FIG. 1 illustrates a new reader device, according to a first configuration of the invention, which is used in place of a legacy credit card reader. Device 10 includes a first section 12 for reading/acquiring information from the credit card/smart card (embedded chip) 15/16 and a second section 14 for biometric sampling (e.g. fingerprint reader, or iris scanner and the like) from user 18. There may be numerous variations of the device, including but not limited to: a single device with areas for each function (i.e. separate sections as depicted in the Figure); a single device with one multipurpose area where a user first places the smart card and then provides the biometric input; two separate devices connected to each other in a wired or wireless manner, for maximum flexibility and so on.

As depicted in FIG. 1, in order for a user to effect a bank card transaction, a merchant provides device 10 and requests presentation of bank card/smart card 15/16 which is brought into proximity of (or contact with) reader 12. Next, user 18 is requested to present a biometric authentication sample. Examples of biometric samples include: a fingerprint (the reference sample is taken by the card issuer, and can be any of the ten fingers, adding an additional level of security as an imposter would not know which finger to present), an iris scan, an image for facial recognition, a voice print or any other biometric sample or combination of samples. Device 10 then cross references the biometric sample data with the reference data on the chip of smart card 16. The stored reference data or partial data thereof and/or encrypted data is accessed by device 10 and compared to the sample data provided by user 18. If predefined thresholds for an acceptable match between the sample data and reference data are met then the transaction is locally approved. In some embodiments of the system, local approval via biometric authentication is sufficient to approve the entire transaction. In other embodiments of the system, conventional approval from the credit card company or financial institution backing the bank card is still needed in addition to the biometric authentication.

Device 10 is capable of performing the credit card transaction as well as the biometric sampling and cross-referencing with the data on the embedded chip. In this embodiment of the invention device 10 replaces the existing/legacy credit card reader.

Credit cards/smart cards 15/16 are becoming more ubiquitous every day. Legacy credit cards have only a magnetic strip which is read by ‘swiping’ the card through a reader. Today, many credit cards have both the magnetic strip and integrated circuits which are easily identified by the gold contact pads seen in SIM cards. In all of the configurations and embodiments discussed herein it is understood that the credit card smart card may be a contact smart card (where the smart card reader connects to the embedded smart card via the contact pads), a contactless smart card (which communicates with, and is powered by, the reader through RF induction technology) or a hybrid contact-contactless smart card.

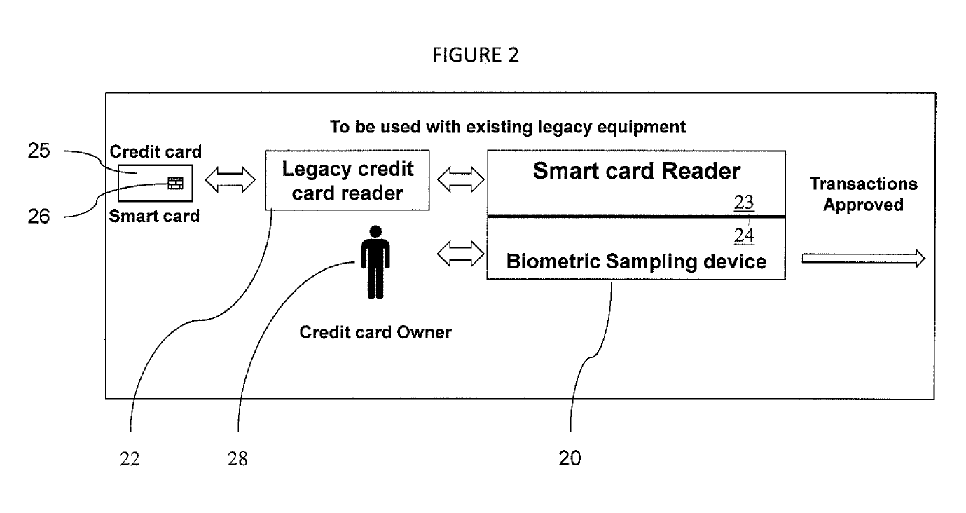

FIG. 2 depicts a second embodiment of the innovative reader of the invention which is used in conjunction with an existing/legacy credit card reader known as a credit card payment terminal. A legacy credit card reader 22 gathers the bank card data from the credit card and feeds the data into a device 20 herein termed an ‘authenticator’. ‘Authenticator’ 20 is made up of a smart card reader 23 and a biometric sampler 24 which receives the biometric input/sample (from the finger, eye, face, etc.) from a user 28 and cross references the sample data with the reference data stored on a smart chip 26 embedded in a credit card 25 which can be read by legacy credit card reader 22. Once authenticated (as described above), the transaction data is approved or at least forwarded to the provider for final approval.

In one variation of the current configuration, the credit card data may be transferred to the provider for approval before or at the same time that the biometric sample is taken/checked. The transaction can be stopped by either the provider or the authenticator. This configuration cuts down a few seconds from the overall transaction time as follows: The merchant swipes the credit card to collect the credit card details which are then sent to the provider; while waiting for approval from the provider/credit card company, the user gives a biometric sample (e.g. fingerprint) by placing the finger on the biometric reader. Authenticator 20 collects the biometric sample (e.g. scans the fingerprint) and cross references the collected sample data with the reference data stored on chip 26. In the meanwhile the approval from the provider comes in and is held by Authenticator 20 until the authentication process is completed. If authentication is achieved, the transaction is concluded. If authentication fails then a message is sent back to the provider cancelling the transaction.

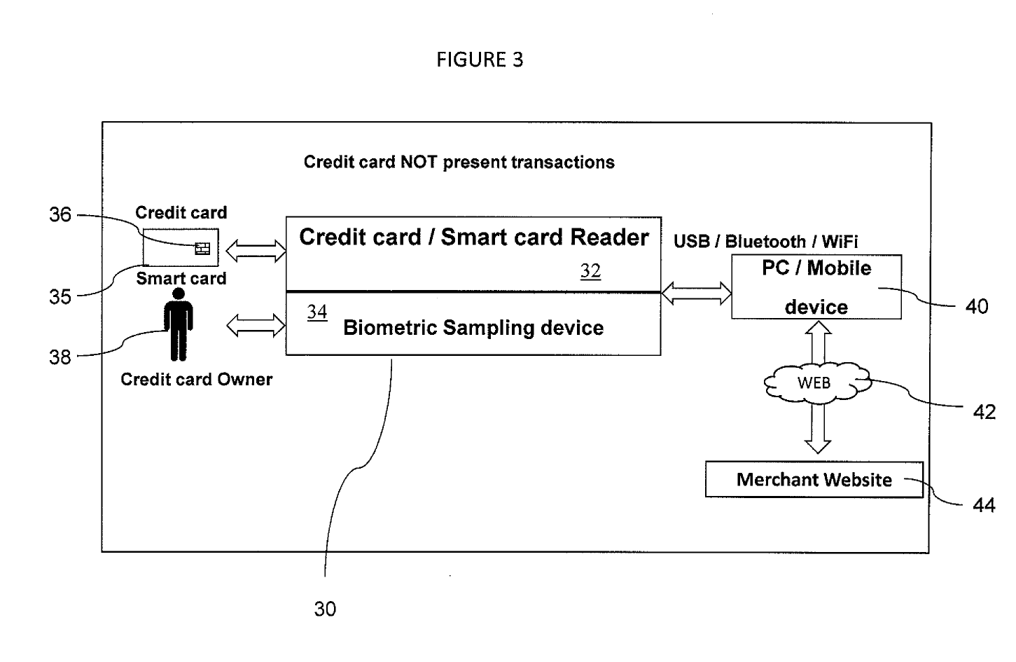

FIG. 3 illustrates a further configuration of the invention which is used for card-not-present transactions. For remote transactions (card not present transactions), a supplementary device can be used along with the appropriate security protocols between the credit card companies, stores, and the reader (such as a challenge-response protocol that is run between the reader and the store, at the end of which, the transcript can be sent to the credit card companies). A reader device 30 is coupled to a computing device (desktop, laptop, tablet, smart phone, PDA etc.) 40, which typically is a personal device of the user, via wired or wireless means (USB cable, Bluetooth, Wi-Fi, NFC etc.). Computing device 40 connects with a merchant website 44 over the Internet or other network 42.

The immediate configuration of the invention affords secure transactions for online purchases. For example, a user 38 uses the browser of computing device 40 to navigate to merchant website 44 in order to purchase an item of clothing. The user adds the item to the ‘shopping cart’ and proceeds to the ‘check-out’ screen. The user is prompted to provide payment details. In the example, merchant website 44 allows biometric authentication or remote credit card transactions and provides an appropriate interface for this payment option. Accessing the interface, user 38 is prompted to ‘swipe’ a credit card 35 or enter the credit card number into the appropriate field provided by the interface. User 38 is then prompted to bring a smart chip 36 (embedded in card 35) into close proximity or contact with a smart card reader 32 of reader device 30. User 38 is then prompted to provide a biometric sample by way of a biometric sampling device 34 which is also part of reader device 30. Reader device 30 authenticates user 38 as the owner of credit card 35 and sends an authentication code via computing device 40 over Internet 42 to merchant site 44 which receives the code and continues to process the credit card information as usual. Any of the aforementioned configuration changes, as well as changes obvious to those skilled in the art, are considered to be included in the scope of the described embodiments.

In some embodiments, a smart phone can be used as a biometric sampler (touch screen fingerprint scanner, camera for facial recognition or iris scan) as well as a smart card reader (over Bluetooth, NFC, RFID etc.) and then relay the information over the Internet to the credit card provider and merchant website. The provider may be a portal to the merchant website or vice versa.

While the invention has been described with respect to a limited number of embodiments, it will be appreciated that many variations, modifications and other applications of the invention may be made. Therefore, the claimed invention as recited in the claims that follow is not limited to the embodiments described herein. received by the International Bureau on 30 Dec. 2013 (30 Dec. 2013).

1. A device for biometric authentication of ownership of a bank card, comprising:
(a) a smart card reader adapted to communicate with a smart chip operationally coupled to the bank card; and
(b) a biometric sampler, configured to collect biometric sample data from a user of the bank card,
wherein the device is configured to cross reference said collected biometric sample data with biometric reference data stored on said smart chip, and wherein a correlation between said collected biometric sample data and said stored biometric reference data authenticates said user as an owner of the bank card.

2. The device of claim 1, wherein said biometric reference data is stored in a manner so as to allow verification while preventing extraction of said biometric reference data by a third party.

3. The device of claim 2, wherein said biometric reference data is manipulated prior to storage using a one-way function that prevents deduction of said biometric reference data from said stored biometric reference data.

4. The device of claim 2, wherein said biometric reference data is subjected to an algorithm selected from the group of secure cryptographic hash functions prior to storage.

5. The device of claim , wherein said biometric reference data is sampled and stored using a secure mechanism that allows high-probability authentication, prevents inversion of said stored biometric reference data, and is adapted to tolerate an accepted variance between said biometric sample data and said biometric reference data.

6. The device of claim 5, wherein, prior to storage, said biometric reference data are subjected to at least one algorithm selected from the group consisting of a fuzzy extractor algorithm, secure sketch algorithm and a secure sketch-like algorithm.

7. The device of claim 1, wherein said biometric sample data correlates to said stored biometric reference data in a predefined manner.

8. The device of claim 1, wherein said communication between said reader and said smart chip is protected against third party manipulation.

9. The device of claim 1, wherein said communication between said reader and said smart chip includes a validation process.

10. The device of claim 9, wherein said validation process includes exchanging cryptographic keys between said reader and said smart chip.

11. The device of claim 9, wherein said validation process includes encrypting said communication.

12. The device of claim 1, wherein a level of authentication is adapted to be manipulated according to a desired level of security.

13. The device of claim 1, wherein said smart chip includes a communication interface selected from the group consisting of: a contact communication interface, a contactless communication interface and a hybrid contact and contactless duel communication interface.

14. The device of claim 1, wherein said smart card reader is further adapted to acquire bank card data of the bank card from said smart chip.

15. The device of claim 1, wherein said smart card reader is operationally coupled to said biometric sampler in a manner selected from the group consisting of: a wired manner and a wireless manner.

16. The device of claim 1, wherein the device is configured to be operationally coupled to a bank card reader.

17. The device of claim 16, wherein the device is further configured to request bank card data verification prior to approval of a transaction request.

18. The device of claim 17, wherein said transaction request if for a transaction selected from the group consisting of: a card-present transaction and a card-not-present transaction.

19. The device of claim 1, wherein said biometric sampler is included in a smart phone.

20. A method for authenticating ownership of a bank card using a biometric sample, comprising the steps of
(a) collecting biometric sample data;
(b) acquiring biometric reference data from a smart chip operationally coupled to the bank card; and
(c) cross-referencing said biometric sample data with said biometric reference data to determine whether said biometric sample data sufficiently matches said biometric reference data to authenticate ownership of the bank card.

21. The method of claim 20, further comprising the step of
(d) disabling the bank card when said biometric sample data fails to sufficiently match said biometric reference data after a predetermined number of attempts to provide said biometric sample data.

22. The method of claim 21, wherein said step of disabling the bank card includes at least one action selected from the group consisting of: blocking the bank card and erasing said biometric reference data from said smart card.

23. The method of claim 20, further comprising the steps of:
(d) acquiring bank card data related to the bank card; and
(e) receiving verification of said bank card data from a verifying body.

24. The method of claim 23, wherein said bank card data is acquired by a smart card reader.

25. The method of claim 23, wherein said bank card data is acquired by a legacy bank card reader.

26. The method of claim 23, further comprising the step of:
(f) approving a transaction request based on said verification of said bank card data and said authentication of ownership of the bank card..

27. The method of claim 26, wherein said transaction request is for a card-present transaction.

28. The method of claim 26, wherein said transaction request is for a card-not-present transaction.

29. The method of claim 20, wherein said biometric sample data is acquired by a biometric sampling device.

30. The method of claim 29, wherein said biometric sampling device is included in a smart phone.

31. The method of claim 20, further comprising the step of:
(d) approving a transaction request for the bank card based on said authentication of ownership of the bank card and at least one additional form of identification, wherein said at least one additional form of identification is selected from the group consisting of: a signature, voice authentication, a password, a PIN code, behaviometric data and credit card data verification.

32. The method of claim 20, further comprising the step of
(d) approving a transaction request for the bank card based only on said authentication of ownership of the bank card.

33. The method of claim 20, further comprising the step of
(d) storing said biometric reference data, prior to step (a), in a manner so as to allow verification while preventing extraction of said biometric reference data by a third party.

34. The method of claim 33, further comprising the step of:
(e) manipulating said biometric reference data, prior to step (d) using a one-way cryptographic function that prevents deduction of said biometric reference data from said stored biometric reference data.

35. The method of claim 33, further comprising the step of:
(e) subjecting said biometric reference data, prior to step (d), to an algorithm selected from the group of secure cryptographic hash functions.

36. The method of claim 20, further comprising the step of
(d) sampling and storing said biometric reference data, prior to step (a), a using secure mechanism that allows high-probability authentication, prevents inversion of said stored biometric reference data, and is adapted to tolerate an accepted variance between said biometric sample data and said biometric reference data.

37. The method of claim 36, further comprising the step of
(e) subjecting said biometric reference data, prior to said step of storing, to at least one algorithm selected from the group consisting of a fuzzy extractor algorithm, a secure sketch algorithm and a secure sketch-like algorithm.
